(19) United States
(12) Patent Application Publication
(10) Pub. No.: US 2002/0107128 A1
(43) Pub. Date: Aug. 8, 2002

(54) Process for manufacturing side fold sacks made of plastic film

(76) Inventor: Uwe Koehn, Osnabrueck (DE)

Correspondence Address: JACOBSON HOLMAN PLLC, 400 SEVENTH STREET N.W., SUITE 600, WASHINGTON, DC, 20004, US

(21) Appl. No.: 10/062,461

(22) Filed: Feb. 5, 2002

(30) Foreign Application Priority Data
Feb. 6, 2001 (DE) 101 06 289.3

(51) Int. Cl. B31B 1/74

(52) U.S. Cl. 493/258

(57) ABSTRACT

To manufacture side fold sacks from a flat lying segment of a web of plastic tubular film, provided with side folds, one end of the segment is provided in such a manner with a staggered cut or a staggered detachment along a perforation that in a top view of the stagger the rear wall projects beyond the front wall. Then the stagger is provided with an application of adhesive as far as into the area of a fold line, which is located in the area of the edge of the front wall that has been cut free. Then the stagger is folded over the fold edge onto the front wall.

The invention relates to a process for manufacturing side fold sacks from a flat lying segment of a web of plastic tubular film.

Side fold sacks made of plastic, for example polyolefin films, like PE and PP, are manufactured from flat lying segments of a web of plastic tubular film by providing a weld, which runs at right angles and grasps all layers, on one end. Owing to the typically high weight of the fill material and the resulting load on the sacks, said sacks are usually made of especially thick plastic films. On tubular segments made of plastic films of such thickness the bottoms can be affixed only by means of transverse welds, whose execution requires a long welding time. The welding operation requires that the heat be passed through all of the layers of film, thus in the area of the side folds through four layers of film, in order to guarantee the requisite melting and welding together. This thermal conductivity process time, which increases as the thickness of the film and the number of layers increase, results in a significantly long welding period so that the sacks can be manufactured only at low efficiency.

Therefore, the object of the invention is to propose a process of the type described in the introductory part and according to which side fold sacks made of plastic film can be manufactured at a higher rate.

The invention solves this problem in that one end of the segment of a web of plastic tubular film is provided in such a manner with a staggered cut or a staggered detachment along a perforation that in a top view of the stagger the rear wall projects beyond the front wall and that the stagger is provided with an application of adhesive as far as into the area of a fold line, which is located in the area of the edge of the front wall that has been cut free, and the stagger is folded over the fold edge onto the front wall. Such a process for manufacturing side fold sacks made of paper already exists. The invention is based on the surprising knowledge and measure of transferring this process known in the manufacture of paper sacks to the manufacture of plastic sacks, where the bottoms were affixed hitherto by means of welds.

Plastic adhesives, for example polyurethane adhesive or hot melt, are used as the adhesive to cement the folded over stagger to the front wall.

The cementing operation can be improved by further subdividing the stagger. Expediently the rear wall projects, in a top view of the stagger, beyond the side folds; and the side folds project beyond the front wall.

The stagger can also grasp the side folds in such a manner that the bottom layers of the side folds project beyond the upper layers.

A preferred embodiment provides that the perforation lines are affixed on a flat lying web of plastic at intervals equal to the length of the segments of a web of plastic tubular film, before said segments are added to a side fold tubular web by folding the web sides so as to overlap and simultaneously inserting side folds and affixing a center weld which runs lengthwise. Thus, starting from the part that forms the rear wall, the perforation lines can pass in steps over those parts that form the side folds into the part that forms the front wall, whereby the transverse segments of the perforation line are parallel to each other. One embodiment of the invention is explained in detail below with reference to the drawings.

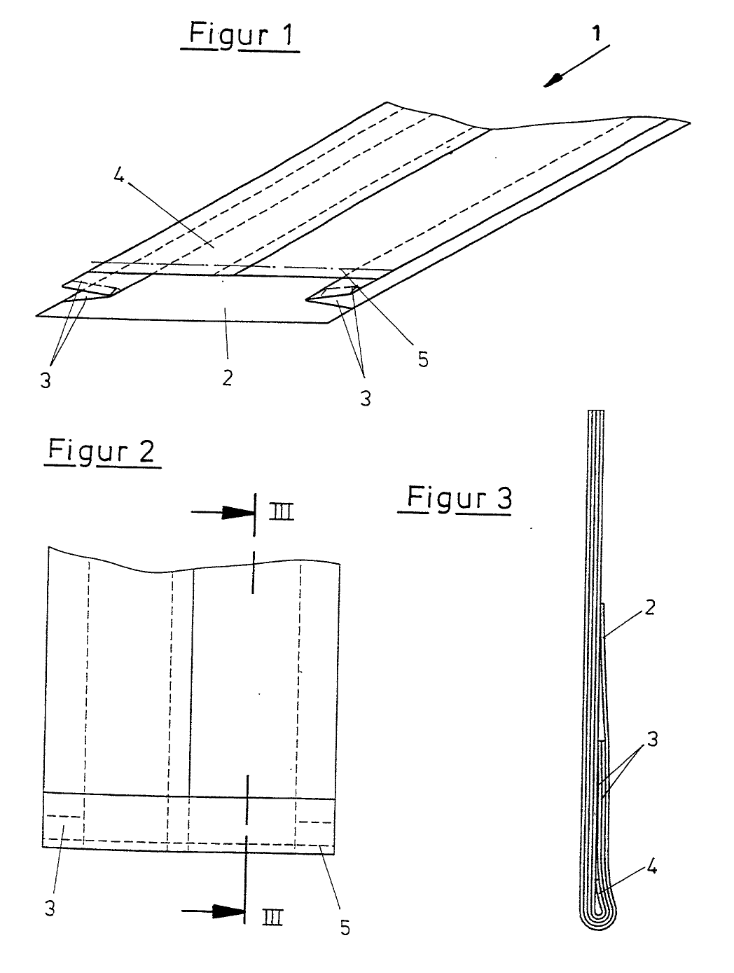

FIG. 1 is a perspective view of one end of a flat lying segment of a web of plastic tubular film, which is provided with side folds, said end being provided with a staggered detachment.

FIG. 2 is a top view of a bottom of a side fold sack made of plastic, said bottom being formed by cementing.

FIG. 3 is a cross sectional view along line III-III of the sack, according to FIG. 2, in an exploded drawing.

FIG. 1 depicts a segment 1 of a web of plastic tubular film, severed along a perforation line from a flat lying web of plastic tubular film, which is provided with side folds. The web of plastic tubular film was provided in such a manner with a perforation line, provided with graduations, that the result is a stagger, which is evident from FIG. 1.

The stagger of the layers on the end of the segment of a web of tubular film, to which the bottom is affixed, is designed in such a manner that in a top view of the segment 1 of a web of tubular film the rear wall 2 projects beyond the side folds 3, while the side folds project beyond the front wall 4, provided with a corresponding free cut. The perforation line, along which the segment of a web of tubular film is severed from the web of tubular film to form the stagger, is already affixed in a flat web of tubular film, from which then the web of tubular film is formed by folding the side parts so as to overlap and simultaneously inserting the side folds and affixing a longitudinal center weld.

To manufacture side fold sacks, the staggered layers 2, 3 are provided with a suitable application of adhesive; and the stagger is then folded over the line 5 and pressed against the front wall 4 so that the result is the cemented bottom, illustrated in FIG. 2.

The position of the staggers in the finished, cemented side fold sack is evident from FIG. 3.

Another embodiment provides that the upper layer of the side folds is also provided with a staggered cut along the dashed lines in FIG. 1.

1. Process for manufacturing side fold sacks from a flat lying segment of a web of plastic tubular film, provided with side folds, characterized in that one end of the segment of a plastic tubular film is provided in such a manner with a staggered cut or a staggered detachment along a perforation that in a top view of the stagger the rear wall projects beyond the front wall and that the stagger is provided with an application of adhesive as far as into the area of a fold line, which is located in the area of the edge of the front wall that has been cut free, and the stagger is folded over the fold edge onto the front wall.

2. Process, as claimed in claim 1, characterized in that the rear wall projects, in a top view of the stagger, beyond the side folds; and the side folds project beyond the front wall.

3. Process, as claimed in claim 1 or 2, characterized in that in the graduation the bottom layers of the side folds project beyond the upper layers of the side folds.

4. Process, as claimed in any one of the claims 1 to 3, characterized in that the perforation lines are affixed on a flat lying plastic web at intervals equal to the length of the segments of a web of plastic tubular film, before said segments are added to a side fold tubular web by folding the web sides so as to overlap and simultaneously inserting side folds and affixing a center weld, which runs lengthwise.

5. Process, as claimed in claim 4, characterized in that, starting from the part that forms the rear wall, the perforation lines can pass in steps over those parts that form the side folds into the part that forms the front wall, and that the transverse segments of the graduated perforation line are parallel to each other.
